(19) United States
(12) Patent Application Publication
(10) Pub. No.: US 2003/0051663 A1
(43) Pub. Date: Mar. 20, 2003

(54) Powder collection system for a powder paint spray booth

(76) Inventor: Edward E. Tomlin, New Boston, MI (US)

Correspondence Address: Douglas W. Sprinkle, Gifford, Krass, Groh, Sprinkle, Anderson & Citkowski, P.C., 280 N. Old Woodward, Suite 400, Birmingham, MI, 48009, US

(21) Appl. No.: 09/957,717

(22) Filed: Sep. 19, 2001

(51) Int. Cl. B05C 5/00

(52) U.S. Cl. 118/326

(57) ABSTRACT

A powder collection system for use with a powder paint spray booth is disclosed having a housing disposed beneath the spray booth. The housing has a pair of sidewalls which taper toward each other from the top and to the bottom of the housing while two spaced end walls close the opposite ends of the housing. A fluidized bed extends along the housing adjacent its bottom and the fluidized bed divides the housing into an upper and a lower chamber. An air induction source is fluidly connected to the upper chamber of the housing so that, upon activation, the air induction source inducts both air and powder from the upper housing chamber. Conversely, a pressure source is fluidly connected to the lower chamber such that the pressurized air agitates the powder paint in the upper chamber and maintains the powder paint in a suspended condition in the upper housing chamber.

### BACKGROUND OF THE INVENTION

I. Field of the Invention

The present invention relates to a powder collection system for use with a powder paint spray booth.

II. Description of the Prior Art

Automotive manufacturers conventionally use paint spray booths in order to paint the automotive vehicles during the manufacturing process. These previously known paint spray booths typically include an upper chamber through which the automotive vehicle is conveyed. Air induction fans draw the excess paint and paint fumes from the paint spray booth through grates and this excess paint and fumes is then typically cleaned from the air before exhausting the air to the atmosphere.

While many previously known paint spray booths have utilized liquid paint to paint the automotive vehicles, many automotive manufacturers are currently utilizing powder paint rather than paint in liquid form. A primary advantage of powder paint, of course, is that powder paint avoids the use of paint solvents and the resulting environmental and health concerns from such paint solvents.

Powder paint, however, is relatively expensive in acquisition costs. For that reason, it would be highly desirable to reclaim any excess paint powder from the spray booth for subsequent use in the painting of subsequent automotive vehicles. The previously known paint spray booths, however, have been designed primarily for use with liquid paint where reclamation of the excess paint is not feasible. For that reason, these previously known automotive paint spray booths have not been able to effectively reclaim the excess powder paint from the paint spray operation.

### SUMMARY OF THE PRESENT INVENTION

The present invention provides a powder collection system for use with a powder paint spray booth which overcomes all of the above-mentioned disadvantages of the previously known devices.

In brief, the powder collection system of the present invention comprises a housing disposed beneath the spray booth. The housing has a pair of sidewalls which slope downwardly from the spray booth and to the bottom of the housing while a pair of end walls close the longitudinally spaced ends of the housing. The housing, furthermore, includes an open top which is adapted to receive the excess powder paint from the spray booth so that the powder paint drops towards the bottom of the housing.

A fluidized bed extends along the housing adjacent its bottom and, in doing so, divides the housing into an upper chamber which is open to the powder paint from the paint spray booth, and a lower chamber. An air induction means is then fluidly connected to the upper chamber so that, upon activation of the air induction means, the air induction means evacuates both air and powder paint particles entrained within the air and toward the air induction means. A gas/solid separator, such as a cyclonic filter, is positioned in series between the upper housing chamber and the air induction means so that the gas/solid separator separates the powder paint from the air for reuse in the paint spray booth.

In order to maintain the paint powder suspended in the air in the upper housing chamber for induction from the upper housing chamber by the air induction means, a source of pressurized air is fluidly connected to the lower housing chamber. This pressurized gas flows through the fluidized bed to the upper housing chamber and maintains the powder paint particles in air suspension.

In the preferred embodiment of the invention, the housing comprises an upper part disposed above the fluidized bed and a lower housing part positioned beneath the fluidized bed. Manually operated quick connect couplings secure the housing parts together and thus provide access to the fluidized bed for cleaning, repair, replacement or the like.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a side view illustrating a preferred embodiment of the present invention;

FIG. 2 is an end view illustrating the preferred embodiment of the present invention;

FIG. 3 is a fragmentary view illustrating the operation of the present invention; and

FIG. 4 is a fragmentary view illustrating a portion of the preferred embodiment of the present invention.

### DETAILED DESCRIPTION OF A PREFERRED EMBODIMENT OF THE PRESENT INVENTION

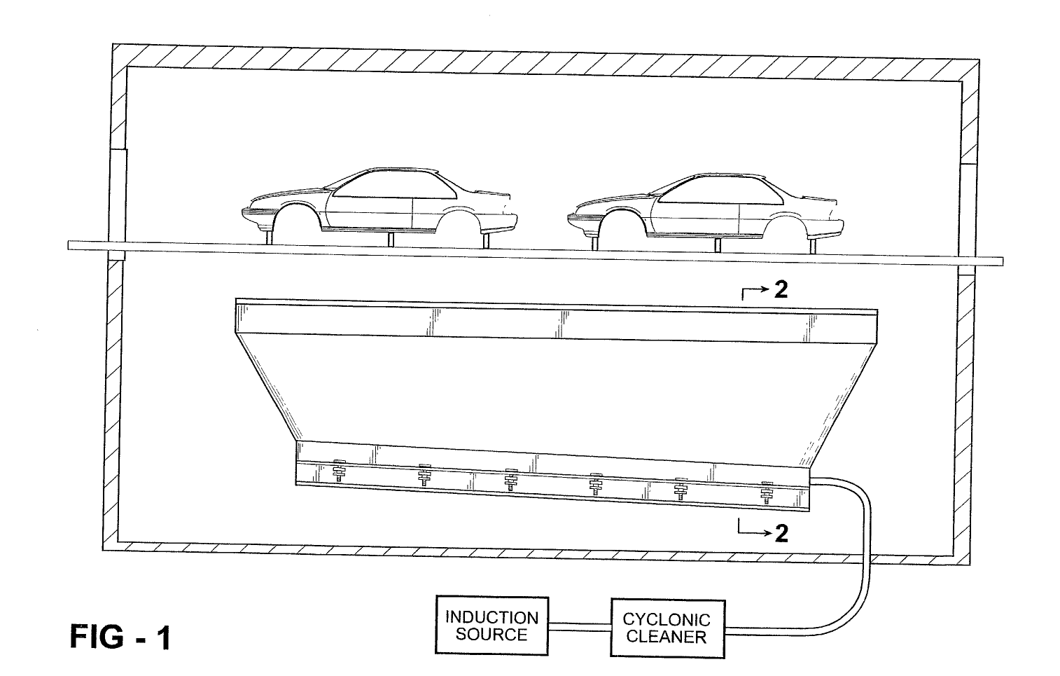

With reference first to FIG. 1, a preferred embodiment of the powder collection system 10 is there shown for use in conjunction with a paint spray booth 12 of the type used in the automotive industry. As such, the paint spray booth 12 is dimensioned so that at least one automotive vehicle 14 is contained within the spray booth 12 and subjected to powder paint. As a practical matter, during any paint spray operation, there will be excess powder paint.

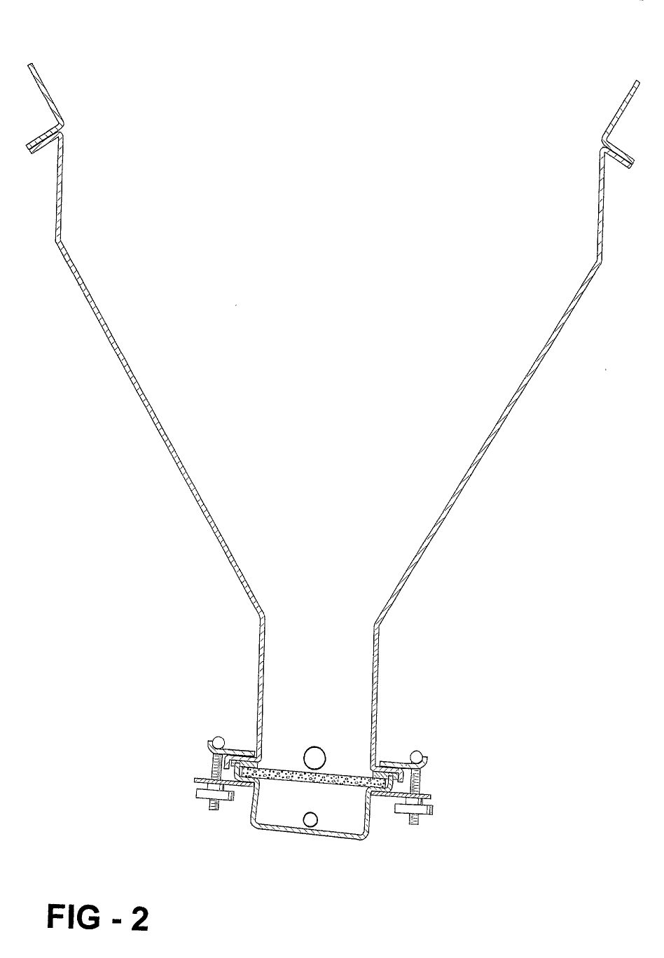

With reference now to FIGS. 1 and 2, the dust collection system 10 comprises a housing 16 having a pair of sidewalls 18. The housing 16 is open at its top 20 and the sidewalls 18 slope towards each other as shown in FIG. 2 so that the housing 16 is narrower at its bottom 22 than at its top 20.

As best shown in FIG. 1, a pair of end walls 24 and 26 close the opposite ends of the sidewalls 18 so that the housing 16 is open only at its top. Additionally, the end walls 24 and 26 taper inwardly towards each other from the top 20 of the housing 16 and towards its bottom 22.

With reference now to FIG. 2, an elongated planar fluidized bed 30 is positioned adjacent to and covers the bottom 22 of the housing 16. In doing so, the fluidized bed 30 divides the housing into an upper chamber 32 and a lower chamber 34. The fluidized bed 30, furthermore, may be of any conventional construction and is porous thereby permitting gas flow through the fluidized bed 30.

With reference now to FIGS. 2 and 4, the housing 16 preferably comprises both an upper part 40 and lower part 42 with the fluidized bed 30 sandwiched in between and separating the housing parts 40 and 42. A plurality of manually operated knobs 44 and threaded fasteners 46 are utilized to secure the housing parts 40 and 42 together and to provide access to the fluidized beds 30 for cleaning, repair and/or replacement. Furthermore, as used in this patent, the phrase “manually operated means”, i.e. the knobs 44, means a fastener which can be fastened or unfastened manually and without the use of hand tools or other tools.

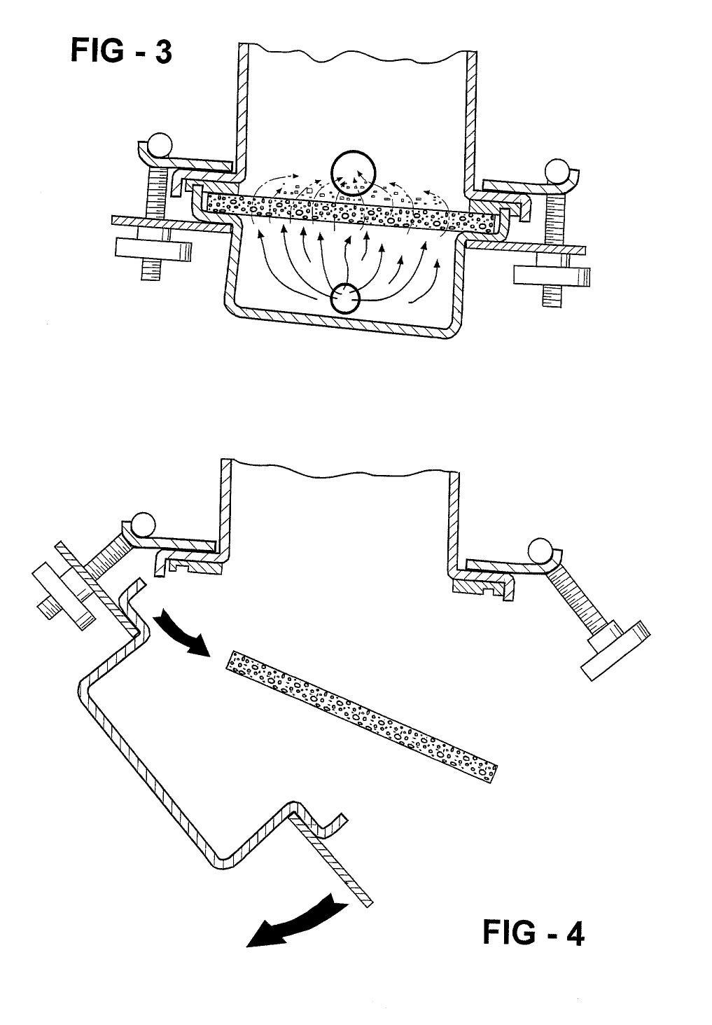

With reference to FIGS. 1 and 3, a fluid port 50 is formed on the housing 16 so that the port 50 is open to the housing upper chamber 32 adjacent the fluidized bed 30. A fluid conduit 52 fluidly connects the port 50 through a gas/solid separator 54, such as a cyclonic cleaner, to an air induction means 56. Consequently, upon activation of the air induction means 56, the air induction means 56 inducts air as well as powder particles entrained within the air through the port 50 and cyclonic cleaner 54. The cyclonic cleaner 54 separates the solid powder particles from the air for reclamation and reuse in the paint spray booth 12.

With reference to FIG. 3, a fluid port 60 is also fluidly connected to the housing 16 but so that the port 60 is open to the lower housing chamber 34. A pressurized air source 62 (illustrated only diagrammatically) is fluidly connected to the fluid port 60 so that, upon activation of the pressurized air source 62, air flows from the source 62, into the lower housing chamber 34, through the fluidized bed 30 and into the housing upper chamber 32 as indicted by arrows 64.

In operation, any conventional means is utilized by the paint spray booth 12 to separate the excess paint powder from the air and then discharge the paint powder into the upper housing chamber 32 through its open top 20. This excess paint powder falls by gravity through the upper housing chamber 32 and towards its bottom 22 of the housing 16.

Activation of the pressurized air source 62 prevents the excess paint powder from accumulating on the upper surface of the fluidized bed 30. Instead, the pressurized air source 62 agitates the excess paint powder and maintains the excess paint powder in suspension in the air in the upper housing chamber 32 adjacent the fluidized bed 30.

Activation of the air induction means 56 then inducts the air from the upper housing chamber 32 with its entrained powder paint through the cyclonic cleaner and to the air induction means 56. The cyclonic cleaner 54 separates the powder paint from the air and this separated powder paint can be reclaimed and reused in the paint spray booth 12. Conversely, the clean air exiting from the cyclonic clear 54 and to the air induction means 56 can be safely expelled to the atmosphere, reused in the paint spray booth 12 or the like. Typically, the induction means 56 and pressure source 62 are continuously and simultaneously activated.

From the foregoing, it can be seen that the present invention provides an inexpensive and yet highly effective powder collection system for use in a powder paint spray booth. Having described my invention, however, many modifications thereto will become apparent to those skilled in the art to which it pertains without deviation from the spirit of the invention as defined by the scope of the appended claims.

I claim:

1. A powder collection system for use with a powder paint spray booth comprising:
a housing disposed beneath the spray booth, said housing having a pair of sidewalls and two spaced apart end walls, said housing having an open top adapted to receive excess paint spray from the paint spray booth,
a fluidized bed extending along said housing adjacent a bottom of said housing, said fluidized bed dividing said housing between an upper chamber and a lower chamber,
means open to said upper chamber of said housing for evacuating fluid from said upper chamber of said housing, and
means open to said lower chamber of said housing for pressurizing said lower chamber of said housing.

2. The invention as defined in claim 1 wherein said housing sidewalls taper toward each other from said open top of said housing and to said bottom of said housing.

3. The invention as defined in claim 1 and comprising an air cleaner fluidly in series between said upper chamber of said housing and said evacuating means.

4. The invention as defined in claim 3 wherein said air cleaner comprises a cyclonic filter.

5. The invention as defined in claim 1 and comprising a fluid port formed in one of said end walls, said port being positioned adjacent said fluidized bed and open to said upper chamber of said housing, said evacuating means being fluidly connected to said port.

6. The invention as defined in claim 5 wherein said fluidized bed slopes downwardly from the other of said end walls and towards said one of said end walls.

7. The invention as defined in claim 1 wherein said housing comprises a first part defining said upper chamber of said housing and a second part defining said lower chamber of said housing, and manually operated means for detachably securing said housing parts together.

8. The invention as defined in claim 7 wherein said detachable securing means comprises threaded fasteners extending through said housing parts.
